(19) United States
(12) Patent Application Publication
(10) Pub. No.: US 2014/0007106 A1
(43) Pub. Date: Jan. 2, 2014

(54) Display and Terminate Running Applications

(71) Applicants: Arnold S. Weksler, Raleigh, NC (US); John Carl Mese, Cary, NC (US); Russell Speight VanBlon, Raleigh, NC (US); Nathan J. Peterson, Durham, NC (US)

(72) Inventors: Arnold S. Weksler, Raleigh, NC (US); John Carl Mese, Cary, NC (US); Russell Speight VanBlon, Raleigh, NC (US); Nathan J. Peterson, Durham, NC (US)

(21) Appl. No.: 13/540,004

(22) Filed: Jul. 2, 2012

(51) Int. Cl. G06F 9/46

(52) U.S. Cl. 718/100

(57) ABSTRACT

An approach is provided to notify users of applications running in the background and to allow users to terminate the application. The applications currently running in the background are identified along with the user configuration settings. The notification type and the action taken vary according to user configuration settings and the amount of resources the background application is consuming. The user may select an application running in the background in order to terminate it.

### BACKGROUND

1. Technical Field

Disclosed is an approach that displays indicators regarding background programs and provides an approach to terminate background programs.

2. Description of the Related Art

Background applications are applications that are constantly running but are not being interacted with by the user. Background applications are used in order to provide more functionality. Background applications are invisible to the user but are constantly working in the background, for example, by checking mail in order to notify the user when a new message is received. While background applications can be useful, they can also be an unnecessary use of valuable resources such as CPU and battery life.

### SUMMARY

An approach is provided to notify users of applications running in the background and to allow users to terminate the application. The applications currently running in the background are identified along with the user configuration settings. The notification type and the action taken vary according to user configuration settings and the amount of resources the background application is consuming. The user may select an application running in the background in order to terminate it.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram of a device, such as a smart phone, notifying the user of applications running in the background and the user terminating an application by selecting the notification icon;

FIG. 4 is a flowchart showing steps taken to identify background applications and the action that should be performed based upon user configuration settings;

FIG. 5 is a flowchart showing configuration steps;

FIG. 6 is a flowchart showing further steps taken to process user selections.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

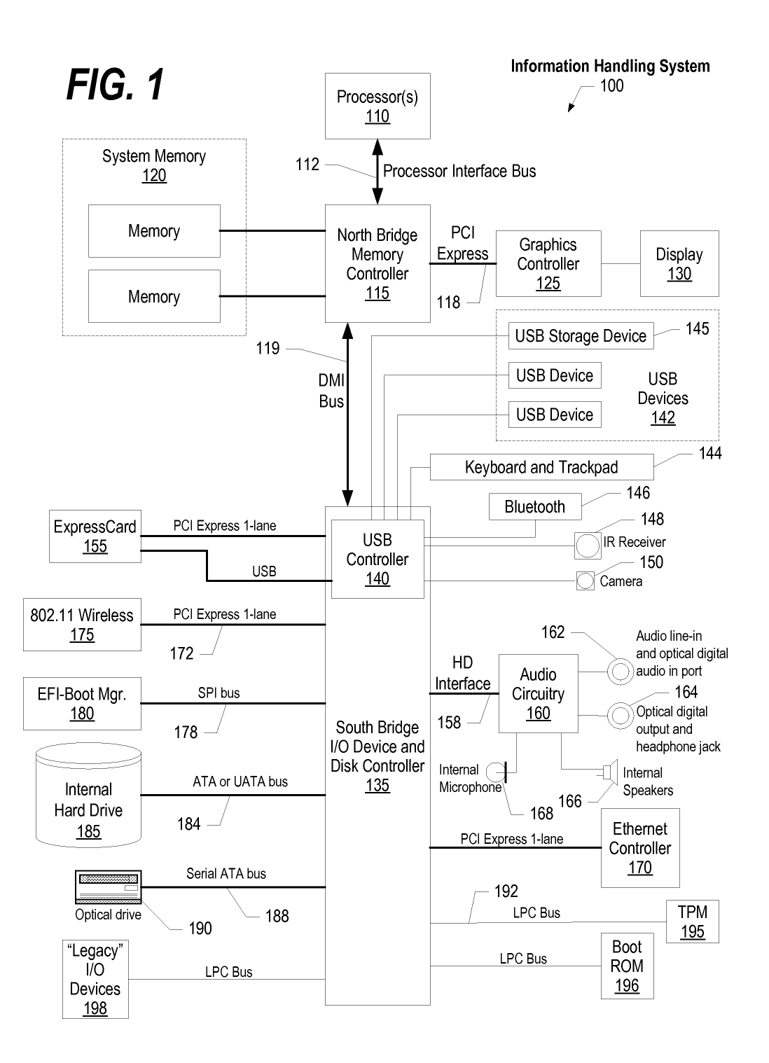

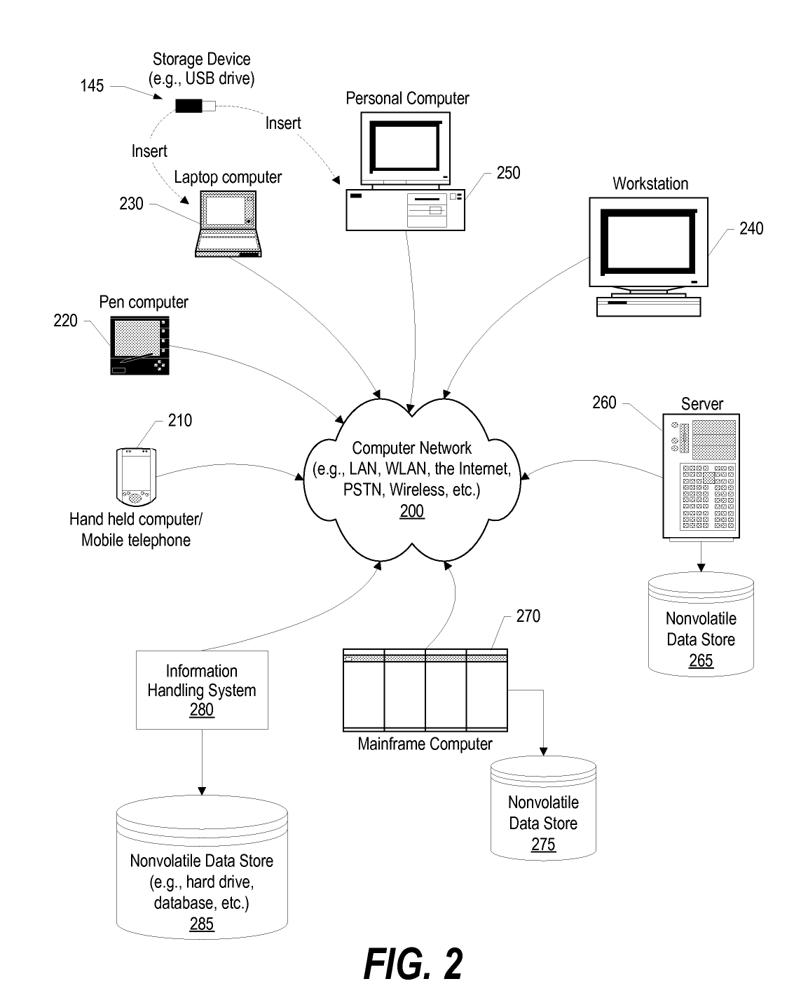

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

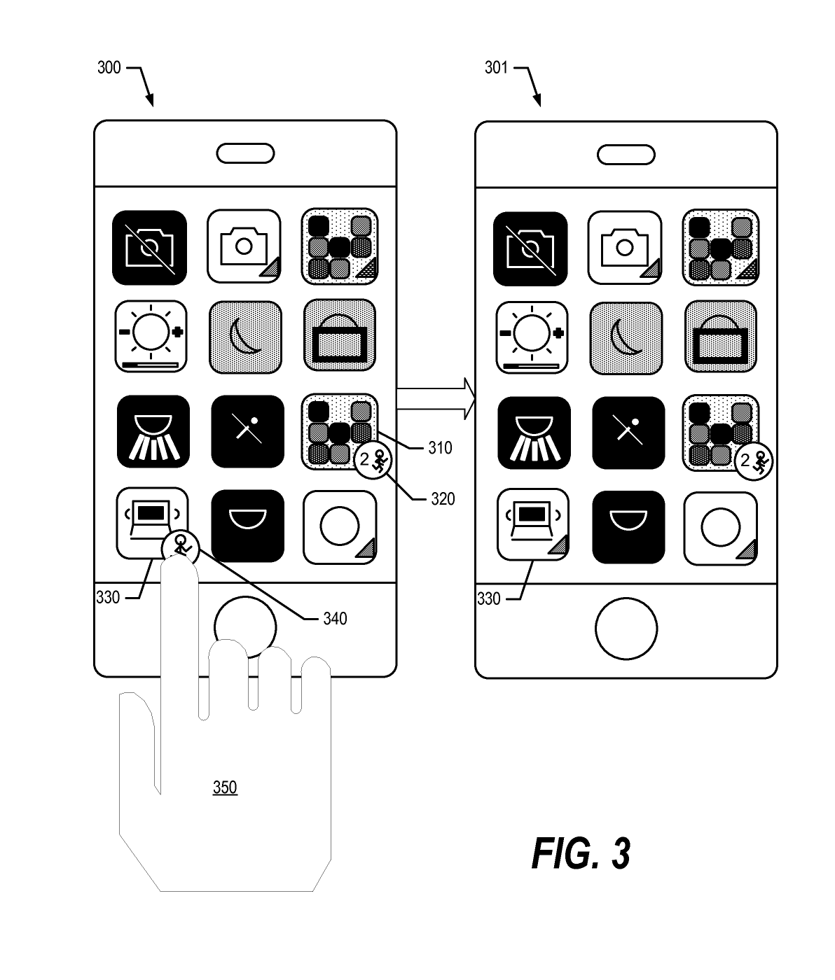

FIG. 3 is a diagram of a device, such as a smart phone, notifying the user of applications running in the background and the user terminating an application by selecting the notification icon. Device view 300 shows a device with a number of icons, or tiles, representing applications available for use on the device. Some of the icons are “group” icons used as a container for other icons (e.g., a folder, or directory, of icons, etc.). One of these groups of icons is group 310. If the user selects group 310, the icons in the selected group (the container) are displayed on the screen of the device. Indicator 320 is displayed proximate to group icon 310. Indicator 320 is an indicator that informs the user that applications are currently running in the group container. In the example shown, indicator 320 shows that two applications within group 310 are currently running.

Icon 330 is an icon representing a single application. Indicator 340, is a visual notification displayed proximate to icon 330. Indicator 340 informs the user that the application represented by icon 330 is currently running. In the example shown, user 350 is selecting indicator 340 in order to terminate application 330 which is running in the background. Resulting device view 301 shows that icon 330 no longer has an indicator showing that the corresponding application is running in the background.

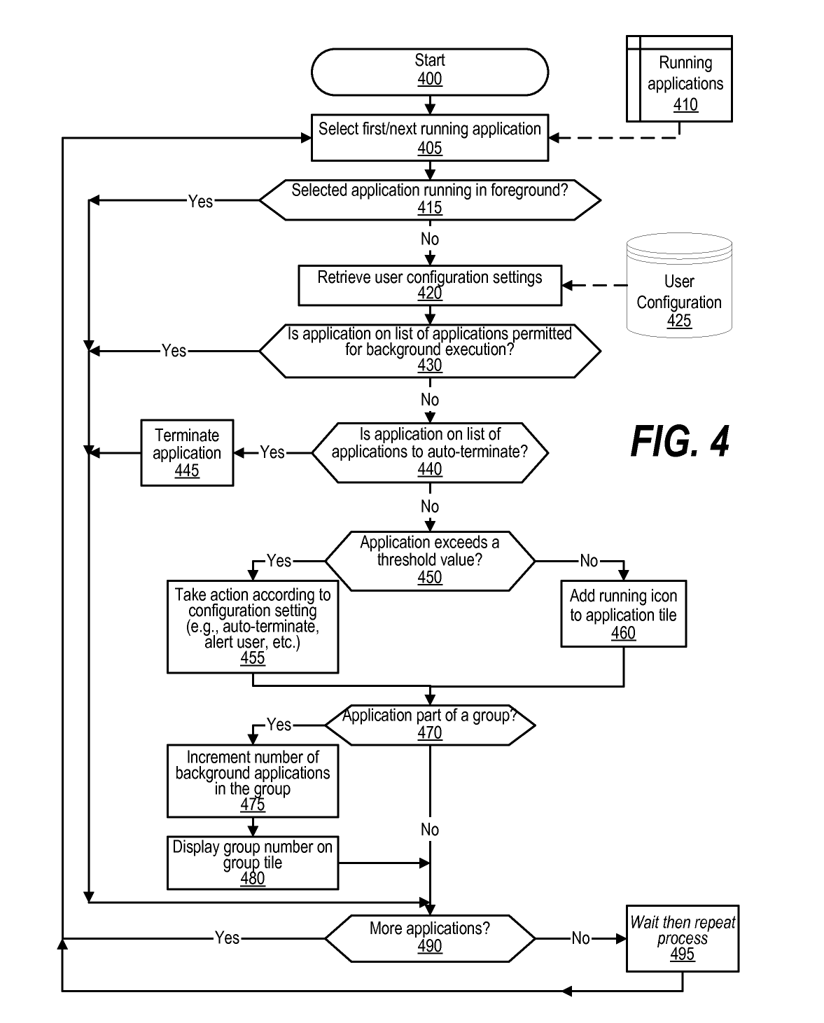

FIG. 4 is a flowchart showing steps taken to identify background applications and the action that should be performed based upon user configuration settings. Processing commences at 400 whereupon, at step 405, the first running application is retrieved from the data store containing the list of running applications (410). The list of running applications may be in a data store maintained by the operating system that manages usage of the device. A determination is made as to whether the selected application is running in the foreground (decision 415). If the selected application is running in the foreground, then decision 415 branches to the “yes” branch which bypasses the remaining steps. On the other hand, if the selected application is not running in the foreground (is instead a background process), then decision 415 branches to the “no” branch whereupon, at step 420, the user configuration settings are retrieved from data store 425 containing the user configuration settings. A determination is made as to whether the selected application is on a list of applications permitted for background execution (decision 430). If the selected application is permitted to run in the background, decision 430 branches to the “yes” branch bypassing the remaining steps. On the other hand, if the selected application is not permitted for background execution, then decision 430 branches to the “no” branch. A determination is made as to whether the selected application is on a list of application to auto-terminate when running in the background (decision 440). For example, games or other non-essential applications may be set to be automatically terminated if they are running in the background. If the selected application is on the list of applications to auto-terminate, then decision 440 branches to the “yes” branch whereupon, at step 445, the selected application is terminated. On the other hand, if the selected application is not on the list of applications to auto-terminate, decision 440 branches to the “no” branch for further processing.

A determination is made as to whether the selected application exceeds a threshold value based on user configuration settings (decision 450). This determination is made by comparing application attributes (e.g., CPU usage, etc.) to threshold values established by the user and stored in user configuration data store 425. If attributes of the selected application exceed a corresponding threshold value, then decision 450 branches to the “yes” branch whereupon, at step 455, action is taken according to user configuration settings (e.g., terminate the application, alert the user, etc.). In addition, in one embodiment, the icon that is displayed is altered at step 455 when a threshold is exceeded. For example, in FIG. 3, a “running man” icon is displayed proximate to an application that is running in the background. When configured, the “running man” icon could be altered at step 455 to indicate that the application is using resources and has exceeded a particular level set by the user (e.g., change color of “running man” icon, depict running man icon running at a faster pace, etc.).

Returning to decision 450, if the attributes of the selected application do not exceed a corresponding threshold value, then decision 450 branches to the “no” branch whereupon, at step 460, an icon indicating that the selected application is running in the background is displayed proximate to the application tile.

A decision is made as to whether the application is part of a group container (decision 470). If the selected application is part of a group container, then decision 470 branches to the “yes” branch. At step 475, the number of running background applications in the group is incremented and, at step 480, the incremented number is displayed proximate to the group tile. Returning to decision 470, if the selected application is not part of a group, decision 470 branches to the “no” branch bypassing steps 475 and 480.

A decision is made as to whether there are more applications running on the device that need to be processed (decision 490). If there are more applications to process, then decision 490 branches to the “yes” branch, which loops back up to step 405 where the next running application is selected. This looping continues until there are no more running applications to process, at which point decision 490 branches to the “no” branch whereupon, at step 495, the process waits for a period of time (e.g., one minute, etc.) before looping back to step 405 to re-process each of the running applications as described above.

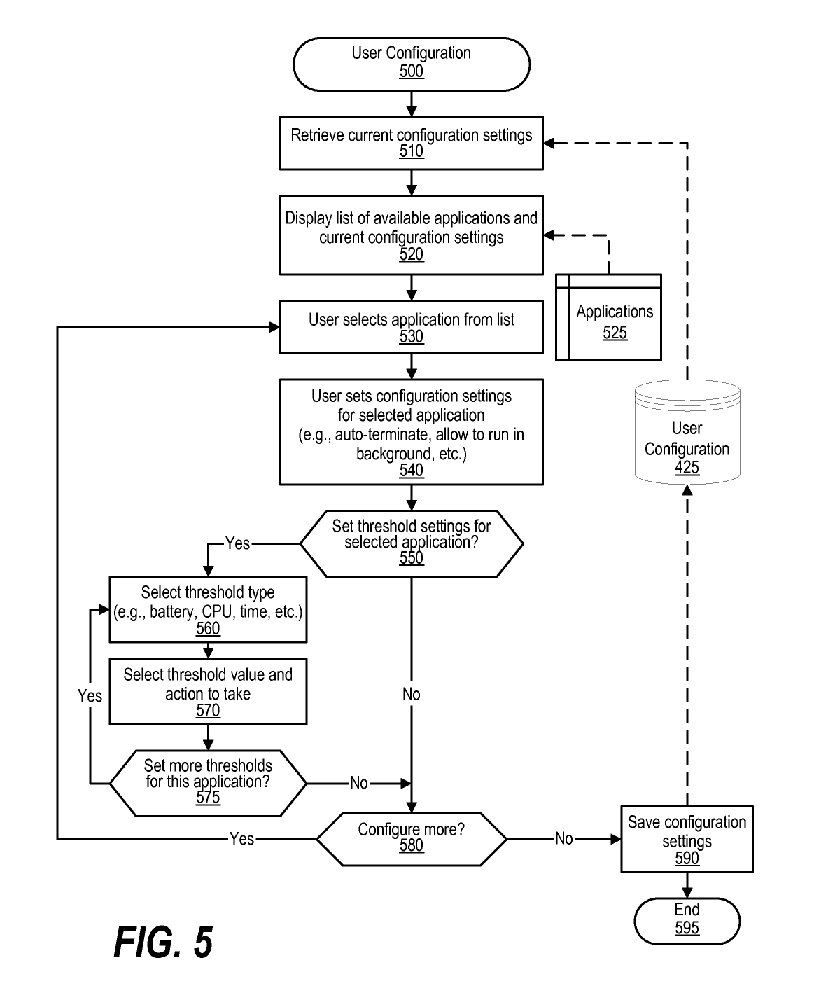

FIG. 5 is a flowchart showing user configuration steps. Processing commences at 500 whereupon, at step 510, the current configuration settings are retrieved from user configuration data store 425. At step 520 the list of available applications and current configuration settings is displayed to the user. This list of available applications is retrieved memory 525. In one embodiment, the operating system maintains applications data store 525. At step 530 the user selects one or more applications from the list. The user can select a single application, a group of applications, or all applications. At step 540 the user sets the configuration settings for the selected applications. For example, the user can set the configuration to automatically terminate the selected applications when running as a background process or can allow the selected applications to run in the background (e.g., a communications processes, etc.). A determination is made as to whether the user wants to set threshold settings for the selected applications (decision 550). If the user wishes to set threshold settings, decision 550 branches to the “yes” branch. At step 560, the user selects the first threshold type to configure for the selected application (or applications). For example, the user can set a threshold type of battery usage, CPU usage, running time, etc. The user selects the threshold value at step 570. For example, the user may select a threshold type of CPU usage and a threshold value of 20% so that the threshold is triggered when the selected application uses 20% or more of the available CPU. In addition, at step 570 the user also selects the action to take when the threshold is reached (e.g., terminate the application, alert the user, etc.). A decision is made as to whether the user wants to set more thresholds for the selected applications (decision 575). If the user wants to set more thresholds for the selected applications, then decision 575 branches to the “yes” branch which loops back to step 560 to select the next threshold type, threshold value, and action to take. This looping continues until the user does not want to set more thresholds, at which point decision 575 branches to the “no” branch. Returning to decision 550, if the user does not want to set any threshold settings for the selected applications, then decision 550 branches to the “no” branch bypassing steps 560 through 575.

A determination is made as to whether the user wants to configure more applications (decision 580). If the user wants to configure more applications, then decision 580 branches to the “yes” branch which loops back to receive the user's next application selections and process the selected application (or applications) as described above. This looping continues until the user no longer wishes to configure additional applications, at which point decision 580 branches to the “no” branch. At step 590 the configuration settings are saved and stored in data store 425. Configuration processing thereafter ends at 595.

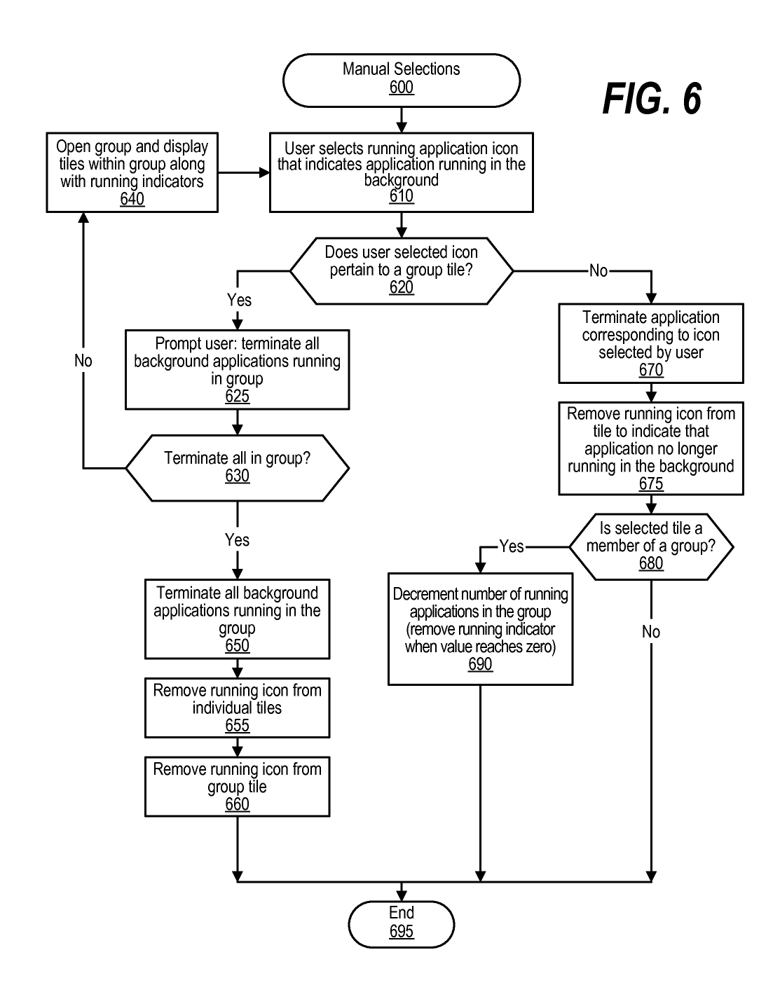

FIG. 6 is a flowchart showing further steps taken to process user selections. Processing commences at 600 whereupon, at step 610. the user selects the visual notification displayed proximate to the application tile with the visual notification indicating the application is running in the background. A determination is made as to whether the icon selected by the user pertains to a group (container) tile or to an individual application. If the user selected tile pertains to a group tile, then decision 620 branches to the “yes” branch to process the selection.

At step 625 the user is prompted as to whether they would like to terminate all of the applications in the selected group that are running in the background. A decision is made as to whether the user wants to terminate all of the applications in the group that are running in the background (decision 630). If the user does not wish to terminate all of the programs in the group that are running in the background, then decision 630 branches to the “no” branch whereupon, at step 640 the group is opened and all of the tiles within the group along with the visual notifications indication which of the applications are currently running in the background are displayed. Processing then loops back to process individual application selections made by the user while viewing the application icons within the selected group.

On the other hand, if the user wants to terminate all of the applications in the group that are currently running in the background, then decision 630 branches to the “yes” branch to terminate the running applications. At step 650, all background applications currently running in the group are terminated. At step 655, the visual notifications displayed proximate to the background-running applications are removed from individual application tiles. At step 660, the visual notification indicating that the group contains running applications is removed from the group tile.

Returning to decision 620, if the user selects a visual notification that does not pertain to a group tile but instead pertains to an individual application that is currently running in the background, then decision 620 branches to the “no” branch to process the selection. At step 670, the application corresponding to the selected visual notification is terminated. At step 675 the visual notification that indicates that the application is running in the background is removed from the tile in order to indicate that the application is no longer running in the background. A determination is made as to whether the selected icon pertains to an application that is a member of a group (decision 680). If the selected icon pertains to an application that is a member of a group, then decision 680 branches to the “yes” branch whereupon, at step 690 the number of applications in the group that are currently running in the background is decremented by one. In addition, if the number of applications in the group that are currently running in the background reaches zero, then the visual notification is also removed from the group tile indicating that no applications in the group are currently running in the background. On the other hand, if the application selected by the user is not a member of a group, then decision 680 branches to the “no” branch bypassing step 690. After the user's selection has been processed, processing ends at 695.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
identifying a background application that is running as a background process on an information handling system;
receiving an input corresponding to the background application;
evaluating the received input; and
selectively terminating the background application in response to the evaluation.

2. The method of claim 1 further comprising:
displaying on a display an icon corresponding to the background application; and
displaying a visual notification proximate to the icon, wherein the notification alerts a user that the background application is running.

3. The method of claim 2 further comprising:
receiving a termination request from the user based on a user selection of the visual notification, wherein the termination request is the received input.

4. The method of claim 2 wherein the displayed icon is a group icon corresponding to a group container wherein a plurality of applications, including the background application, are running as background processes, and wherein the method further comprises:
identifying a number of the applications, including the background application, that are running as background processes;
displaying the identified number, wherein the number is displayed proximate to the group icon; and
receiving a termination request from the user based on a user selection of the number being displayed proximate to the group icon, wherein the termination request is the received input, and wherein the termination includes termination the plurality of background applications.

5. The method of claim 1 further comprising:
retrieving a configuration setting that configures auto-termination of one or more applications; and
comparing the one or more application with the background application, wherein the termination of the background application is executed in response to the comparison.

6. The method of claim 1 further comprising:
retrieving one or more performance attributes corresponding to the background application;
retrieving one or more threshold values;
comparing the retrieved performance attributes with the retrieved threshold values;
identifying an action based on the comparison; and
executing the identified action.

7. The method of claim 6 wherein the action is selected from the group consisting of a termination action, an audible alert, a visual alert, and a device vibration.

8. An information handling system comprising:
one or more processors;
a memory coupled to at least one of the processors;
a nonvolatile storage area coupled to at least one of the processors; and
a set of instructions stored in the memory and executed by at least one of the processors in order to perform actions of:
identifying a background application that is running as a background process on the information handling system;
receiving an input corresponding to the background application;
evaluating the received input; and
selectively terminating the background application in response to the evaluation.

9. The information handling system of claim 8 wherein the processors perform additional actions comprising:
displaying on a display an icon corresponding to the background application; and
displaying a visual notification proximate to the icon, wherein the notification alerts a user that the background application is running.

10. The information handling system of claim 9 wherein the processors perform additional actions comprising:
receiving a termination request from the user based on a user selection of the visual notification, wherein the termination request is the received input.

11. The information handling system of claim 9 wherein the displayed icon is a group icon corresponding to a group container wherein a plurality of applications, including the background application, are running as background processes, and wherein the processors perform additional actions comprising:
identifying a number of the applications, including the background application, that are running as background processes;
displaying the identified number, wherein the number is displayed proximate to the group icon; and
receiving a termination request from the user based on a user selection of the number being displayed proximate to the group icon, wherein the termination request is the received input, and wherein the termination includes termination the plurality of background applications.

12. The information handling system of claim 8 further comprising:
retrieving a configuration setting that configures auto-termination of one or more applications; and
comparing the one or more application with the background application, wherein the termination of the background application is executed in response to the comparison.

13. The information handling system of claim 8 wherein the processors perform additional actions comprising:
retrieving one or more performance attributes corresponding to the background application;
retrieving one or more threshold values;
comparing the retrieved performance attributes with the retrieved threshold values;
identifying an action based on the comparison; and
executing the identified action.

14. The information handling system of claim 13 wherein the action is selected from the group consisting of a termination action, an audible alert, a visual alert, and a device vibration.

15. A computer program product stored in a computer readable storage medium, comprising computer instructions that, when executed by an information handling system, causes the information handling system to perform actions comprising:
identifying a background application that is running as a background process on the information handling system;
receiving an input corresponding to the background application;
evaluating the received input; and
selectively terminating the background application in response to the evaluation.

16. The computer program product of claim 15 wherein the actions further comprise:
displaying on a display an icon corresponding to the background application; and
displaying a visual notification proximate to the icon, wherein the notification alerts a user that the background application is running.

17. The computer program product of claim 16 wherein the actions further comprise:
receiving a termination request from the user based on a user selection of the visual notification, wherein the termination request is the received input.

18. The computer program product of claim 16 wherein the displayed icon is a group icon corresponding to a group container wherein a plurality of applications, including the background application, are running as background processes, and wherein the actions further comprise:
identifying a number of the applications, including the background application, that are running as background processes;
displaying the identified number, wherein the number is displayed proximate to the group icon; and
receiving a termination request from the user based on a user selection of the number being displayed proximate to the group icon, wherein the termination request is the received input, and wherein the termination includes termination the plurality of background applications.

19. The computer program product of claim 15 wherein the actions further comprise:
retrieving a configuration setting that configures auto-termination of one or more applications; and
comparing the one or more application with the background application, wherein the termination of the background application is executed in response to the comparison.

20. The computer program product of claim 15 wherein the actions further comprise:
retrieving one or more performance attributes corresponding to the background application;
retrieving one or more threshold values;
comparing the retrieved performance attributes with the retrieved threshold values;
identifying an action based on the comparison; and
executing the identified action.
